(19) United States
(12) Patent Application Publication
(10) Pub. No.: US 2007/0008693 A1
(43) Pub. Date: Jan. 11, 2007

(54) Clamping structure of an electronic device

(76) Inventors: Che-Fu Yeh, Taipei (TW); Yaw-Song Chen, Taipei (TW); Chung-Hung Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,841

(22) Filed: Jul. 5, 2005

(51) Int. Cl. G06F 1/16

(52) U.S. Cl. 361/685

(57) ABSTRACT

A clamping structure of an electronic device for fastening an electronic device to a host inside of electronic equipment includes a supporting device and a tray. The supporting device has a space, which has a clamping tab, an L-shape orientation member, a guiding tab, and a fixed lock that are disposed therein. The tray is accommodated with an electronic device, the bottom of which has a clamping slot. One side of the tray has a projection and a track projection. The tray is disposed in the space of the supporting device and is moved a predetermined distance. The fixed lock, the guiding tab, the L-shape orientation member, and the clamping tab of the supporting device are respectively clamped to the track projection, the projection and the clamping slot of the tray. Therefore, the electronic device is convenient for assembling, detaching, and maintenance.

### BACKGROUND OF THE INVENTION

1. Field of the Invention

The present invention relates to a clamping structure of an electronic device, and more particularly, to an electronic device such as a hard disc, a CD-ROM drive and so on which are arranged to an electronic equipment not through the use of screws, thereby the electronic device for assembling and detaching are vastly more convenient.

2. Description of Related Art

Electronic devices such as hard discs, CD-ROM drives and so on are important data store devices for computers. Electronic devices demanded by the consumer market need to be supplied cheaply, have high operating speeds and large storage capacity for running an operating system, application programs and other data. If the computer has no hard discs and CD-ROM drives or the storage space of the hard discs and CD-ROM drives is insufficient, the operation and efficiency of the computer will be impacted greatly.

Referring to FIG. 1, a conventional electronic device 90 such as a hard disc, a CD-ROM drive and so on use great numbers of screws 91 to arrange to a body 92 of a host, however the inside space of the body 92 is limited and the screw 91 is inconvenient to take out once it is locked in or put it back in later.

As such, fabrication and disassembly of such an electronic device 90 is not easy.

Accordingly, as discussed above, the prior art still has some drawbacks that could be improved upon. The present invention aims to resolve the drawbacks in the prior art.

### SUMMARY OF THE INVENTION

An objective of the present invention is to provide a clamping structure of an electronic device, and the electronic device is arranged to the electronic equipment in a clamping manner, not by using screws, thereby making the fabrication and disassembly of the electronic device convenient and easy to repair.

For reaching the objective above, the present invention provides a clamping structure of an electronic device for attaching an electronic device to the inside of a main machine of electronic equipment, comprising: a supporting device arranged to the inside of a main machine of electronic equipment and having a space, in which a clamping tab can be set; a tray having an accommodating space for accommodating the electronic device and a bottom board of the tray having a clamping slot; wherein, the tray is disposed to the space of the supporting device and the tray is moved a predetermined distance, then the clamping slot of the tray and the clamping tab of the supporting device are clamped to each other.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of an arranged structure of an electronic device f the prior art;

FIG. 2 is an exploded view of the present invention;

FIG. 3 is an exploded view of another angle of the present invention;

FIG. 4 is a combinative view of the present invention;

FIG. 5 is a schematic of between a slip track projection and an orientation projection of the present invention (1); and

FIG. 6 is a schematic of between the slip track projection and the orientation projection of the present invention (2).

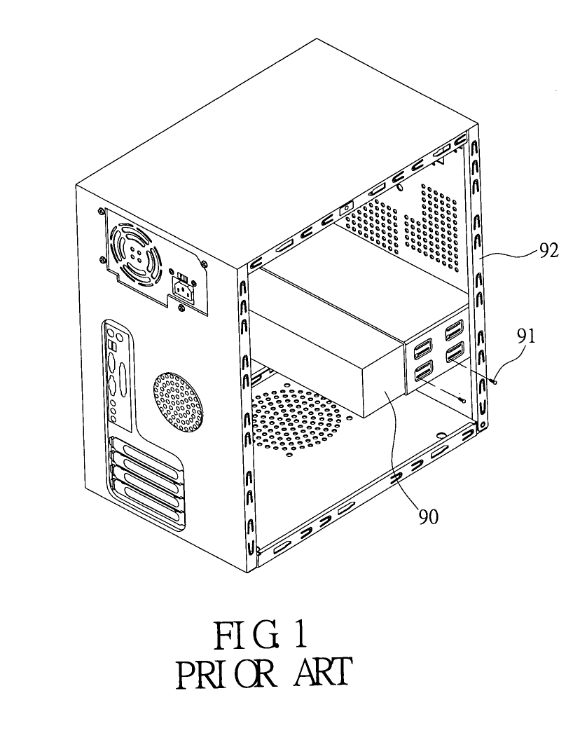

### DETAILED DESCRIPTION OF PREFERRED EMBODIMENTS

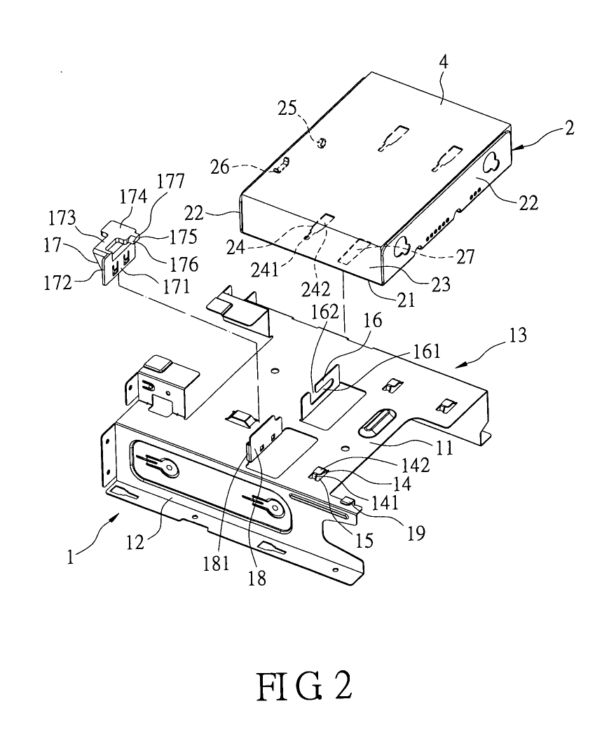

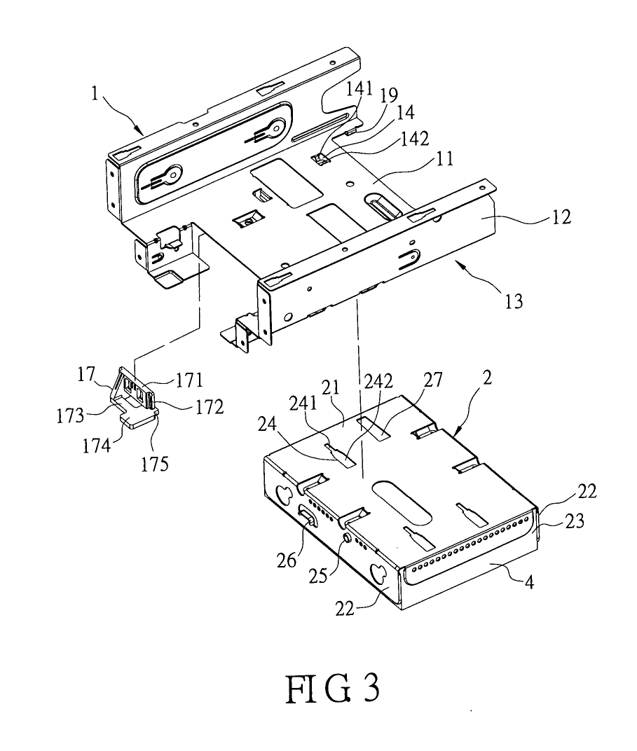

Referring to FIGS. 2 to 4, the present invention provides a clamping structure of an electronic device and more particularly, for electronic devices such as hard discs, CD-ROM drives and so on which are arranged inside electronic equipment, includes a supporting device 1 and a tray 2; wherein the supporting device 1 is arranged inside a host, the supporting device 1 is made of metal, the supporting device 1 has a bottom board 11 which has two sides extending downwardly to form a sideboard 12 for using the two sideboards 12 to attach the supporting device 1 inside the host, and the top of the bottom board 11 forms a space 13 for accommodating the tray 2 and the electronic device 4.

The top of the bottom board 11 of the supporting device 1 is perforated with many clamping tabs 14, the clamping tabs 14 form holes 15 respectively, and the clamping tabs 14 on top of the bottom board 11 extend into the space 13. The clamping tabs 14 have a narrow portion 141 and a wide portion 142 respectively. The width of the narrow portion 141 is smaller than that of the wide portion 142. The end of the narrow portion 141 and the wide portion 142 of the clamping tabs 14 are connected to the bottom board 11. The top of the bottom board 11 of the supporting device 1 is punched an L-shape orientation member 19 and the clamping tabs 14. The L-shape orientation member 19 can be used either alone or together with the clamping tabs 14.

The top of the bottom board 11 of the supporting device 1 is punched with a guiding tab 16, and the guiding tab 16 is erected on the bottom board 11. The guiding tab 16 is located inside the space 13, and is vertical to the bottom board 11. The guiding tab 16 has an L-shape guiding slot 161. The end of the guiding slot 161 has an opening 162. The opening 162 is located above the guiding tab 16.

The top of the bottom board 11 of the supporting device 1 is punched with a fixed tab 18. The side of the fixed tab 18 has a fixed lock 17 arranged to it. The fixed lock 17 is located inside the space 13. The fixed lock 17 has a body 171, and the two sides of the body 171 forms a flange 172 respectively for using bend portion 181 of two sides of the fixed tab 18 to cover the two flange 172The fixed lock 17 is arranged to the side of the fixed tab 18. The side of the body 171 is connected to an elastic arm 173, and the end of the elastic arm 173 is connected to a large area of the moving portion 174. The side of the moving portion 174 is disposed to an orientation projection 175. The end of the orientation projection 175 has an arcing guiding surface 176. The other end of the orientation projection 175 forms an end 177.

Tray 2 accommodates an electronic device 4. The tray 2 is made of metal. The tray 2 has a bottom board 21 and the two sides of the bottom board 21 extend upwardly to form a sideboard 22. Between the bottom board 21 and the two sideboards 22 an accommodating space 23 are formed for accommodating the electronic device 4.

The bottom board 21 of the tray 2 is disposed with many clamping slots 24 corresponding to the clamping tabs 14. The clamping slots 24 are rectangle slots, which are longer than the clamping tabs 14. The width of the narrow slot 241 is smaller than that of the wide slot 242. The clamping slots 24 each have a narrow slot 241 and a wide slot 242. The top of the bottom board 21 of the tray 2 is disposed a long trapezium clamping slot 27 corresponding to an L-shape orientation member 19. The end of the clamping slot 27 has a wide slot.

One of the sideboards 22 of the tray 2 has a projection 25 and a track projection 26 corresponding to the guiding tab 16 and the fixed lock 17. The projection 25 is a hollow pillar, which is projected outside of the sideboard 22. The track projection 26 is a U-type tab, which is projected outside of the sideboard 22.

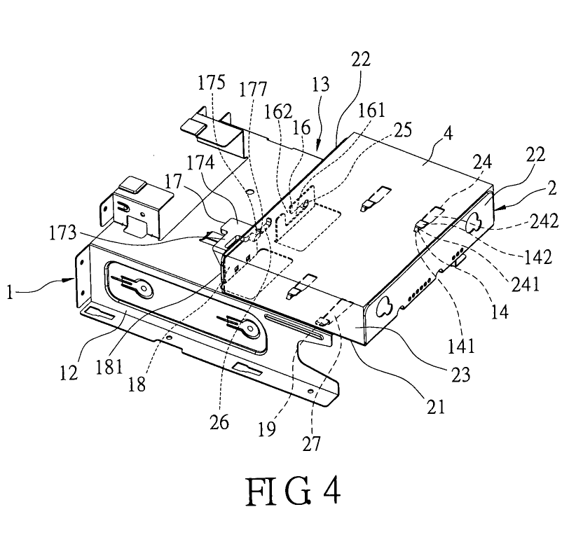

The tray 2 is disposed inside the space 13 of the supporting device 1. The clamping tabs 14 and the L-shape orientation member 19 of the bottom of the supporting device 1 are matched with the wide slot 242 of the clamping slot 24 and the long trapezium clamping slot 27 of the bottom of the tray 2. The tray 2 is pushed a predetermination distance along in a vertical direction so that the narrow portion 141 and the wide portion 142 of the clamping tabs 14 slip into the narrow slot 241 of the clamping slot 24 (see FIG. 4). The wide portion 142 of the clamping tabs 14 passes through the wide slot 242 of the clamping slot 24 for clamping into the narrow slot 241 of the clamping slot 24. Simultaneously the L-shape orientation member 19 passes through the wide slot of the clamping slot 27 of the tray 2 to clip onto the bottom of the tray 2 for limiting the upward movement of the tray 2.

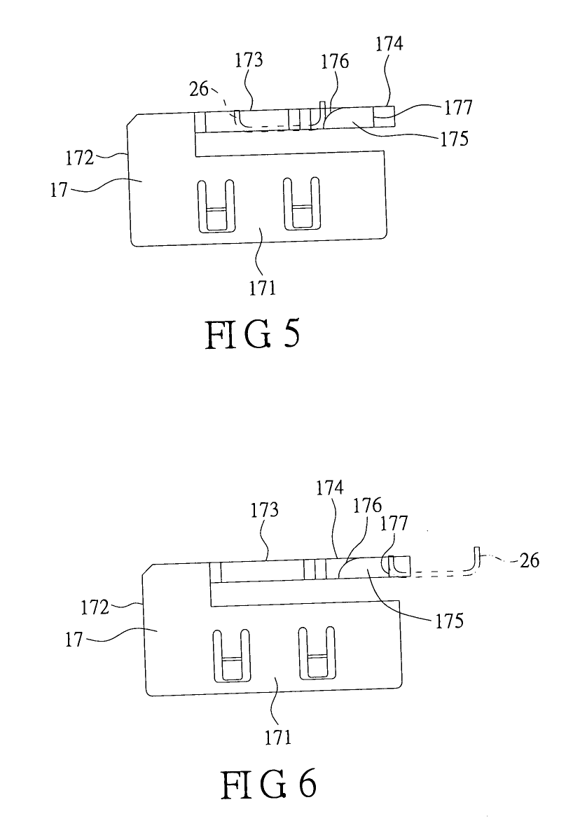

As the tray 2 is disposed inside of the space 13 of the supporting device 1, the projection 25 of the side of the tray 2 is disposed into the end of the guiding slot 161 by the opening 162 of the guiding tab 16. The track projection 26 of the side of the tray 2 corresponds to the orientation projection 175 of the fixed lock 17. Thus the tray 2 is pushed a predetermination distance along in a vertical direction. The projection 25 slips into the guiding slot 161, and the end of the track projection 26 first contacts the guiding surface 176 of the orientation projection 175 of the fixed lock 17 (see FIG. 5) so that the track projection 26 is slide into the top orientation projection 175 by the guiding surface 176. The end 177 of the other end of the orientation projection 175 blocks the track projection 26 (see FIG.6). The projection 25 and the guiding slot 161 match each other for limiting any up-down displacement force from the tray 2. The orientation projection 175 and the track projection 26 match each other for limiting any vertical displacement force from the tray 2, so that the tray 2 is stably orientated in the space 13 of the supporting device 1.

To remove the tray 2 and the electronic device 4 from the space 13 of the supporting device 1, the user only needs to turn down the moving portion 174 of the fixed lock 17, and then move the tray 2 forward. The end 177 of the orientation projection 175 departs from the track projection 26, allowing the tray 2 to be moved along in the withdrawing direction. To withdraw the clamping tabs 14 from the clamping slots 24, the projection 25 needs to be withdrawn from the guiding slot 161 of the guiding tab 16. Thereby the tray 2 and the electronic device 4 are withdrawn from the space 13 of the supporting device 1; thereby the clamping structure of an electronic device of the present invention is formed.

According to the present invention, the fixed lock 17, the guiding tab 16, the L-shape orientation member 19, and the clamping tabs 14 of the supporting device 1 are respectively clamped to the track projection 26, the projection 2 and the clamping slots 24 and 27 of the tray 2. Thereby the tray 2 is stably clamped onto the supporting device 1 without screws and thereby reducing the occupied space of the host compared to that occupied by the prior art. Therefore, the clamping structure is convenient for attaching, detaching, and maintenance of the electronic device.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A clamping structure of an electronic device for fastening the electronic device to an inside of a host of an electronic equipment, comprising:
a supporting device arranged to the inside of the host of the electronic equipment and having a space in which a clamping tab is set; and
a tray having an accommodating space for receiving the electronic device and a clamping slot formed on a bottom thereof;
wherein the tray is received in the space of the supporting device and moved a predetermined distance so that the clamping tab of the supporting device is matched with the clamping slot of the tray for clamping the clamping device and the tray to each other.

2. The clamping structure as claimed in claim 1, wherein the supporting device has a bottom board on which the space is formed, and the clamping tab is disposed on the bottom board.

3. The clamping structure as claimed in claim 2, wherein the clamping tab is projected from a top of the bottom board of the supporting device, the clamping tab has a narrow portion and a wide portion, the clamping slot of the tray is divided into a narrow slot and a wide slot, and the wide portion of the clamping tab passes through the wide slot of the clamping slot to clamp into the narrow slot.

4. The clamping structure as claimed in claim 1, wherein the supporting device has a guiding tab with a guiding slot in the space, a side of the tray has a projection, and the projection of the tray and the guiding slot of the guiding tab of the supporting device are clamped to each other.

5. The clamping structure as claimed in claim 4, wherein the guiding slot of the guiding tab is formed in a L-shape, and one end of the guiding slot forms an opening, which is placed on top of the guiding tab.

6. The clamping structure as claimed in claim 1, wherein the tray has a bottom board and two sideboards, the accommodating slot is formed between the bottom board and the two sideboards of the tray, and the clamping slot is disposed on the bottom board of the tray.

7. The clamping structure as claimed in claim 1, wherein the supporting device has a fixed lock with an orientation projection in the space, the side of the tray has a track projection, and the track projection of the tray and the orientation projection of the fixed lock of the supporting device are clamped to each other.

8. The clamping structure as claimed in claim 7, wherein the fixed lock has a body, and a side of the body is connected with an elastic arm, one end of the elastic arm is connected with a moving portion, the orientation projection is disposed on a side of the moving portion, the orientation projection has an arc-shaped guiding surface formed on an end thereof and an end is formed on an opposite end thereof for orientating the track projection.

9. A clamping structure of an electronic device for fastening an electronic device to an inside of a host of an electronic equipment, comprising:
a supporting device arranged to the inside of the host of the electronic equipment and having a space in which an L-shape orientation member is set; and
a tray having an accommodating space for accommodating an electronic device and a bottom of the tray having a clamping slot;
wherein the tray is disposed in the space of the supporting device and moved a predetermined distance so that the L-shape orientation member of the supporting device passes through the wide slot of the clamping slot of the tray for clipping onto the bottom of the tray.
